(19) United States
(12) Patent Application Publication
(10) Pub. No.: US 2019/0156407 A1
(43) Pub. Date: May 23, 2019

(54) RENTAL FEE SETTING APPARATUS, METHOD AND SYSTEM

(71) Applicant: TOYOTA JIDOSHA KABUSHIKI KAISHA, Toyota-shi (JP)

(72) Inventors: Hiroshi IGATA, Yokohama-shi (JP); Shin SAKURADA, Toyota-shi (JP); Kuniaki JINNAI, Nagoya-shi (JP); Motoyoshi HATTA, Anjo-shi (JP); Shota HIROSE, Toyoake-shi (JP)

(73) Assignee: TOYOTA JIDOSHA KABUSHIKI KAISHA, Toyota-shi (JP)

(21) Appl. No.: 16/194,895

(22) Filed: Nov. 19, 2018

(30) Foreign Application Priority Data
Nov. 21, 2017 (JP) 2017-223550

(51) Int. Cl. G06Q 30/06; G06Q 30/02

(52) U.S. Cl. CPC G06Q 30/0645; G06Q 30/0284

(57) ABSTRACT

When a condition for setting a fee is established, a management server performs: determining a target of setting the fee; obtaining a utilization plan; when a nationwide utilization plan is not selected and a set-area utilization plan is instead selected, setting a correction coefficient C(1) corresponding to the number of stations; setting a correction coefficient C(3) corresponding to the number of stations each with an electric charging device; setting a correction coefficient C(4) corresponding to the number of stations each with a quick electric charging device; obtaining a utilization history; and when there is no utilization beyond the plan, setting a monthly fee.

This nonprovisional application is based on Japanese Patent Application No. 2017-223550 filed on Nov. 21, 2017 with the Japan Patent Office, the entire contents of which are hereby incorporated by reference.

### BACKGROUND

### Field

The present disclosure relates to setting a rental fee for an electric vehicle.

### Description of the Background Art

Conventionally, there is a rental system known to rent an electric vehicle to a user and collect a rental fee. In renting an electric vehicle in such a rental system, allowing a user to make an advance reservation of an electric vehicle to use it for a time zone can achieve an increased utilization rate.

For example, Japanese Patent Laying-Open No. 2009-048357 discloses calculating a utilization fee depending on a user's frequency of utilization scheduled for a next month, and preferentially permitting the user to make a reservation depending on the amount of the utilization fee as calculated.

### SUMMARY

In renting electric vehicles, it is desirable to provide a large number of stations each serving as a base for renting the electric vehicles for convenience for users. However, different geographical regions in which electric vehicles are utilized have different populations and hence different utilization rates and accordingly there may be an uneven distribution between the number of stations in a geographical region and the number of stations in another geographical region. Accordingly, some geographical region may be different in convenience regarding rental of electric vehicles, and when a rental fee is set irrespective of a condition of a geographical region where an electric vehicle is utilized, the set fee may not be able to sufficiently satisfy a user in a geographical region including a small number of stations.

An object of the present disclosure is to provide a rental fee setting apparatus, method and system that sets a rental fee of an electric vehicle to be rented to a user while considering a condition of a geographical region where the vehicle is utilized so that the user is sufficiently satisfied with the set rental fee.

According to one aspect of the present disclosure, a rental fee setting apparatus is a rental fee setting apparatus configured to set a rental fee for an electric vehicle comprising a power storage device mounted therein. The present rental fee setting apparatus comprises: a storage device configured to store a movement range selected by a user from a plurality of movement ranges, the plurality of movement ranges including (i) a first movement range allowing the electric vehicle to move therein when the electric vehicle is rented and (ii) a second movement range being different from the first movement range and including a smaller number of stations each serving as a base for renting the electric vehicle than the first movement range; and a setting device configured to set a rental fee for the electric vehicle based on the selected movement range. The setting device is configured to set a lower rental fee when the second movement range is selected than when the first movement range is selected.

For a movement range with a smaller number of stations, a rental fee of a smaller amount is set, and thus a rental fee of a smaller amount will be set than for a convenient geographical region having a larger number of stations (e.g., a geographical region in which it is easy to charge a power storage device mounted in an electric vehicle and the electric vehicle is thus subsequently rentable in a shorter period of time). As a result, a fee can be set to sufficiently satisfy a user in a geographical region including a small number of stations.

In an embodiment, when a number of stations with an electric charging device in the first movement range is different from a number of stations with an electric charging device in the second movement range, the setting device is configured to set different rental fees for the movement ranges.

When the first and second movement ranges have different numbers of stations each with an electric charging device installed therein, a user's convenience in utilizing an electric vehicle varies between the first and second movement ranges. By setting a different rental fee while considering a condition of a geographical region in which the vehicle is utilized, the rental fee can sufficiently satisfy a user.

In an embodiment, when a number of stations with a quick electric charging device in the first movement range is different from a number of stations with a quick charging device in the second movement range, the setting device is configured to set different rental fees for the movement ranges.

When the first and second movement ranges have different numbers of stations each with a quick electric charging device installed therein, a user's convenience in utilizing an electric vehicle varies between the first and second movement ranges. By setting a different rental fee while considering a condition of a geographical region in which the vehicle is utilized, the rental fee can sufficiently satisfy a user.

In an embodiment, the rental fee setting apparatus further comprises a reservation receiving device configured to receive a reservation for rental of the electric vehicle for a scheduled utilization period of time, the reservation receiving device receiving the reservation no earlier than a reservation receivable time point earlier by a predetermined period of time than a starting time of the scheduled utilization period of time. The storage device is configured to store in association with the user a grade of a plurality of grades set in accordance with a predetermined criterion. The predetermined period of time is set for each grade.

For example, when the predetermined period of time is set to be longer for a grade with more privileges than a grade with fewer privileges, a user set to the grade with more privileges can be treated preferentially.

A method according to another aspect of the present disclosure is a method for setting a rental fee for an electric vehicle comprising a power storage device mounted therein. The present method comprises: storing a movement range selected by a user from a plurality of movement ranges, the plurality of movement ranges including (i) a first movement range allowing the electric vehicle to move therein when the electric vehicle is rented and (ii) a second movement range being different from the first movement range and including a smaller number of stations each serving as a base for renting the electric vehicle than the first movement range; setting a rental fee for the electric vehicle based on the selected movement range; and setting a lower rental fee when the second movement range is selected than when the first movement range is selected.

According to still another aspect of the present disclosure, a rental fee setting system comprises: an electric vehicle including a power storage device mounted therein; and a server configured to set a rental fee for the electric vehicle. The server is configured to store a movement range selected by a user from a plurality of movement ranges, the plurality of movement ranges including (i) a first movement range allowing the electric vehicle to move therein when the electric vehicle is rented and (ii) a second movement range being different from the first movement range and including a smaller number of stations each serving as a base for renting the electric vehicle than the first movement range. The server is configured to set a rental fee for the electric vehicle based on the selected movement range. The server is configured to set a lower rental fee when the second movement range is selected than when the first movement range is selected.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is an overall configuration diagram of a rental fee setting system according to the present embodiment.

FIG. 2 is a diagram showing an example of a configuration of an electric vehicle.

FIG. 3 shows an example of a user list.

FIG. 4 is a diagram for illustrating a movement range set for a point-to-point utilization plan.

FIG. 5 is a diagram for illustrating a movement range set for a set-area utilization plan.

FIG. 6 is a flowchart of a rental fee setting process.

FIG. 7 is a diagram for explaining a correction coefficient set depending on the number of stations.

FIG. 8 is a diagram for explaining a correction coefficient set depending on a distance between two geographical points.

FIG. 9 is a diagram for explaining a correction coefficient set depending on the number of stations in each of which an electric charging device is installed.

FIG. 10 is a diagram for explaining a correction coefficient set depending on the number of stations in each of which a quick electric charging device is installed.

FIG. 11 is a flowchart of a reservation receiving process.

### DESCRIPTION OF THE PREFERRED EMBODIMENTS

The present disclosure will now be described in embodiments hereinafter in detail with reference to the drawings. In the figures, identical or corresponding components are identically denoted and will not be described repeatedly.

<Configuration of Rental Fee Setting System>

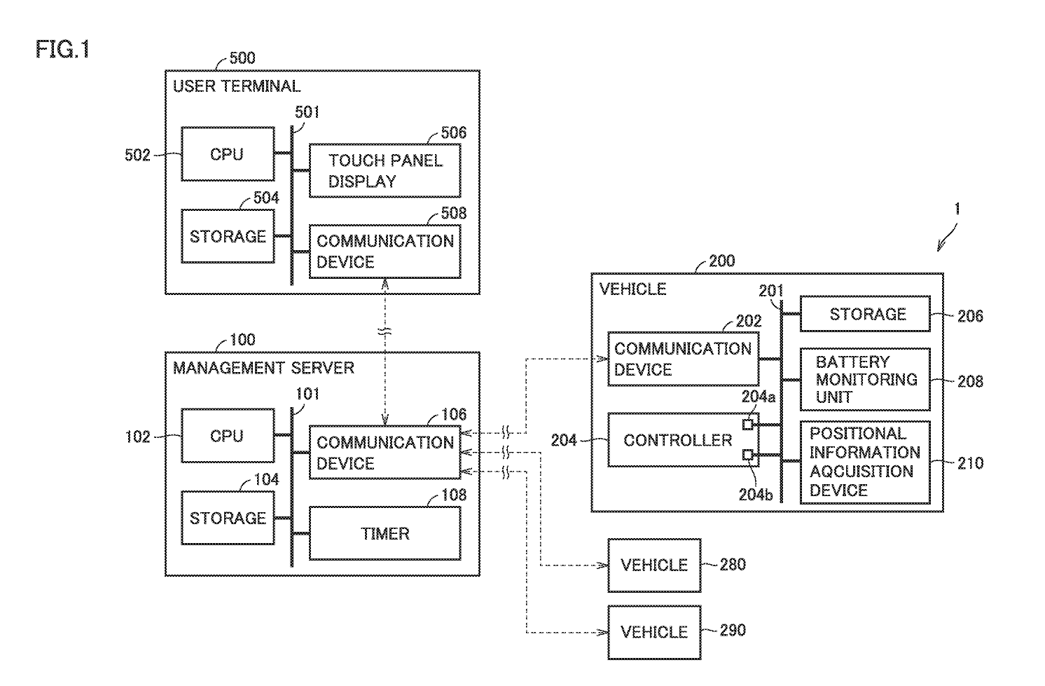

FIG. 1 is an overall configuration diagram of a rental fee setting system 1 according to the present embodiment. As shown in FIG. 1, rental fee setting system 1 according to the present embodiment includes a management server 100, vehicles 200, 280 and 290 which are electric vehicles, and a user terminal 500.

Management server 100 includes a CPU (Central Processing Unit) 102, a storage 104, a communication device 106, and a timer 108. Each component is communicatively connected by a communication bus 101.

CPU 102 is configured to execute prescribed computation processing based for example on information stored in storage 104, information received from vehicle 200 via communication device 106, and/or the like.

Storage 104 includes, for example, a memory such as a ROM (Read Only Memory) and a RAM (Random Access Memory), and a large-capacity storage device such as a hard disk or a solid state drive. Storage 104 stores, for example, information associating the plurality of vehicles 200, 280, 290 with the user of each vehicle (a user list, a reservation list or a utilization history).

For example, communication device 106 is configured to communicate with at least any of communication device 202 of vehicle 200 and communication device 508 of user terminal 500. For example, communication device 106 and communication device 202 communicate information with each other through wireless communication. Communication device 106 and communication device 202 may communicate via a relay point (a wireless base station), a prescribed communication network (for example, the Internet), or the like, or may not communicate via a relay point, a prescribed communication network or the like. Further, communication device 106 is configured to similarly communicate with both vehicle 280 and vehicle 290.

The wireless communications may be done in a wireless communication system capable of transmitting and receiving signals via a relay point utilizing a wireless LAN (Local Area Network) represented by IEEE 802.11, a wireless communication standard for a mobile phone such as 2G, 3G, 4G, 5G, etc., and the like, or may be done in a wireless communication system capable of transmitting and receiving signals directly between communication device 106 and communication device 202 and for example utilizing a wireless communication standard such as Bluetooth (Registered trademark) or the like.

Communication device 106 and communication device 508 communicate in a manner similar to a manner in which communication device 106 and communication device 202 communicate. Communication device 106 and communication device 508 may communicate in a communication system which is identical to or different from that in which communication device 106 and communication device 202 communicate.

Timer 108 counts the current date and time. For example, CPU 102 stores in storage 104 a result of counting time by timer 108. When reading the current date and time from storage 104, CPU 102 may correct the current date and time by an externally received digital signal (standard radio wave) including date information and time information.

Vehicle 200 includes communication device 202, a controller 204, a storage 206, a battery monitoring unit 208, and a positional information acquisition device 210. Each component is communicatively connected by a communication bus 201.

For example, communication device 202 is configured to communicate with communication device 106 of management server 100. Communication device 106 and communication device 202 wirelessly communicate as has been described above, and accordingly, how they do so will not be described redundantly.

Controller 204 includes, for example, a CPU 204a, a memory 204b (ROM and RAM), an input/output port for inputting and outputting various signals (not shown) and so forth. Controller 204 is configured to execute prescribed computation processing based on the information stored in memory 204b and storage 206, information received from management server 100 via communication device 202, and the like.

Storage 206 is a storage device that can store data of a larger size than memory 204b, and is, for example, a storage device composed of a nonvolatile memory, a hard disk, a solid state drive, or the like. Storage 206 stores, for example, a driving history of vehicle 200 (for example, a history of positional information (that is, a travelled route)), or the like.

Battery monitoring unit 208 detects a state of a battery 214 mounted in vehicle 200. Battery monitoring unit 208 detects, for example, battery 214's voltage, current and temperature. Battery monitoring unit 208 calculates an estimated value of an SOC of battery 214 by using for example the detected voltage, current and temperature of battery 214. The SOC may be estimated using a well-known technique, and a detailed description thereof will not be provided. Note that the SOC may be estimated by controller 204 rather than battery monitoring unit 208.

Positional information acquisition device 210 is configured to obtain the current position of vehicle 200. For example, positional information acquisition device 210 may obtain the current position of vehicle 200 by using GPS (Global Positioning System), or may obtain the current position of vehicle 200 by using positional information of a wireless communication device located outside vehicle 200 and capable of communicating with communication device 106. Positional information acquisition device 210 transmits to controller 204 a signal indicating the current position of vehicle 200 as obtained.

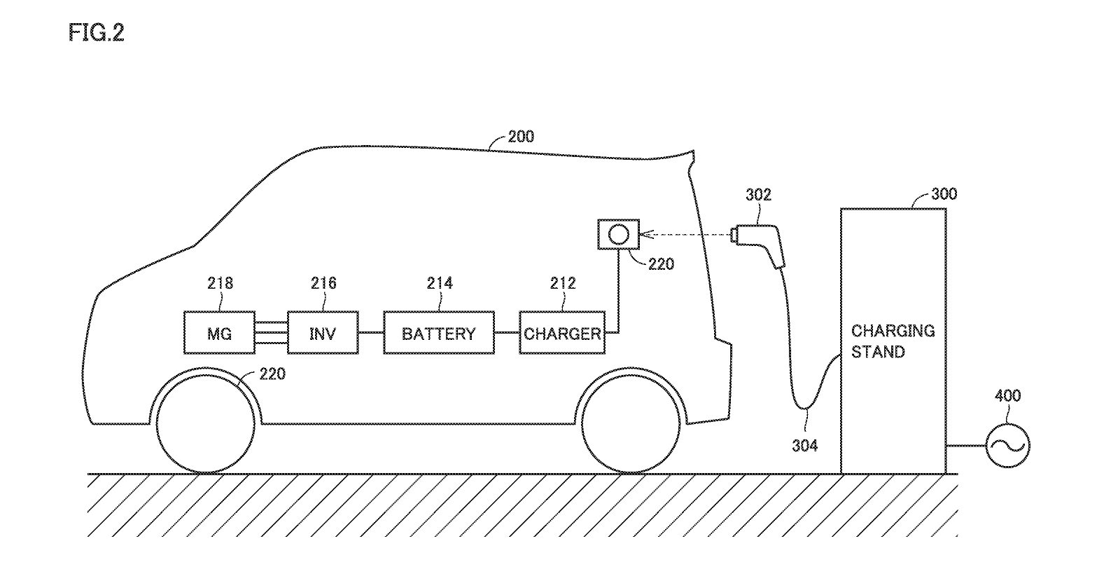

Vehicle 200 is an electric vehicle using an electric motor as a driving power source. FIG. 2 is a diagram showing an example of a configuration of the electric vehicle.

As shown in FIG. 2, vehicle 200 further includes a charger 212, battery 214, an inverter 216, a motor generator 218, and an inlet 220.

When a charging stand 300 has a charging connector 302 attached to inlet 220, charger 212 charges battery 214 with power supplied from an external power supply 400.

Battery 214 is configured using, for example, a secondary battery such as a nickel metal hydride battery or a lithium ion battery. Battery 214 may be any power storage device capable of storing power, and for example, a large-capacity capacitor may be used instead of battery 214.

Inverter 216 is a power conversion device which converts power between AC power and DC power. Inverter 216 may for example convert DC power of battery 214 into AC power and supplies it to motor generator 218. Further, inverter 216 may for example receive AC power (regenerative power) from motor generator 218, convert it into DC power, and supply it to battery 214 to electrically charge battery 214 therewith.

Motor generator 218 receives power supplied from inverter 216 and provides rotational force to a drive wheel 222. Drive wheel 222 is rotated by the rotational force provided by motor generator 218 to drive vehicle 200.

Inlet 220 is provided to vehicle 200 at an exterior portion of vehicle 200 together with a cover (not shown) such as a lid. Inlet 220 has a shape allowing charging connector 302 to be attached thereto. Inlet 220 and charging connector 302 both have contacts, respectively, incorporated therein. When charging connector 302 is attached to inlet 220, the contacts come into contact with each other, and inlet 220 and charging connector 302 are thus electrically connected together.

Charging stand 300 is installed outside vehicle 200 and connected to charging connector 302 via a charging cable 304. Charging stand 300 is electrically connected to power supply 400, and when charging connector 302 is attached to inlet 220, the power of power supply 400 is supplied via charging stand 300, charging cable 304, and charging connector 302 to vehicle 200.

Vehicles 280 and 290 are similar in configuration to vehicle 200. Accordingly, they will not be described redundantly.

User terminal 500 includes a CPU 502, a storage 504, a touch panel display 506, and a communication device 508. Each component is communicatively connected by a communication bus 501.

CPU 502 is configured to execute prescribed computation processing based on, for example, information stored in storage 504, information received from management server 100 via communication device 508, and the like. Storage 504 is composed of memory such as ROM and RAM, for example.

Touch panel display 506 is configured by providing a touch panel on a surface of a display screen of a liquid crystal display. Touch panel display 506 transmits to CPU 502 an operation signal generated by an operation done by the user on the touch panel. The liquid crystal display of touch panel display 506 displays an image based on a control signal issued from CPU 502. Note that touch panel display 506 may be configured such that an input device such as a keyboard and a mouse and a display device such as a liquid crystal display are provided separately.

Communication device 508 is configured to communicate with communication device 106 of management server 100, for example. Communication device 508 and communication device 106 wirelessly communicate as has been described above, and accordingly, how they do so will not be described redundantly.

For example, a user can make a reservation via user terminal 500 to rent any of vehicles 200, 280 and 290 for a scheduled utilization period of time.

<Manner of Utilization of Electric Vehicle>

In the present embodiment, as a manner of utilization of an electric vehicle, for example, a user can select for example any of: leasing an electric vehicle until a prescribed term of a contract (of one year or plural years) expires (i.e., leasing); setting a fee per unit period of time and collecting when a vehicle is returned a rental fee depending on a period of time for which the vehicle is utilized (i.e., renting); and allowing a plurality of people to share one or more electric vehicles until a prescribed term of a contract expires (i.e., sharing).

Of these manners of utilization, for example, when an electric vehicle is rented, a rental fee corresponding to how vehicle 200 has been utilized may be set when vehicle 200 is returned. Alternatively, for example, when an electric vehicle is leased, a rental fee may be set for each prescribed period or time (for example of one month). Furthermore, for example, when an electric vehicle is shared, an amount obtained by adding a fee for each prescribed period of time and a fee depending on utilizing the vehicle may be set as a rental fee.

In renting an electric vehicle, it is desirable to provide a large number of stations each serving as a base for renting the electric vehicle for convenience for users. However, different geographical regions in which electric vehicles are utilized have different populations and hence different utilization rates and accordingly there may be an uneven distribution between the number of stations in a geographical region and the number of stations in another geographical region. Accordingly, some geographical region may be different in convenience regarding rental of electric vehicles, and when a rental fee is set irrespective of a condition of a geographical region where an electric vehicle is utilized, the set fee may not be able to sufficiently satisfy a user in a geographical region including a small number of stations.

Accordingly, in the present embodiment, management server 100 stores a movement range selected by a user from a plurality of movement ranges including a first movement range allowing a rented electric vehicle to move therein and a second movement range being different from the first movement range and including a smaller number of stations each serving as a base for renting the electric vehicle than the first movement range. Management server 100 sets a rental fee for the electric vehicle with the selected movement range considered. More specifically, when the second movement range is selected as a movement range, management server 100 sets a rental fee of a smaller amount than when the first movement range is selected for the sake of illustration. In the present embodiment, management server 100 corresponds to a “rental fee setting apparatus.”

This allows a lower rental fee to be set for a movement range having a smaller number of stations therein. Thus, a rental fee lower than for a more convenient geographical region is set. A fee can be set to sufficiently satisfy a user in a geographical region including a small number of stations.

In the following description, a user selects one of a plurality of utilization plans to select a movement range in advance (i.e., before the user rents an electric vehicle). For each utilization plan, a movement range is generally determined, and selected by a user specifically.

In the present embodiment, the utilization plans include, for example, a point-to-point utilization plan, a set-area utilization plan, and a nationwide utilization plan. The point-to-point utilization plan is a plan in which travelling between two geographical points selected by a user is set as a movement range permitted when an electric vehicle is rented for the sake of illustration. The set-area utilization plan is a plan in which a geographical region selected by a user on a municipal basis is set as a movement range for the sake of illustration. The nationwide utilization plan is a plan in which the municipalities throughout a country are set as a movement range (that is, a rented electric vehicle has a limitless movement range).

<Example of Configuration of User List>

Management server 100 associates a user ID for identifying a user who rents an electric vehicle, a grade set for the user, a utilization plan selected, and information accompanying the utilization plan, and stores them to storage 104 as a user list. Management server 100 refers to the user list stored in storage 104 to set a rental fee (a monthly fee) for each prescribed period of time (for example of one month), set a rental fee depending on how the vehicle is utilized (a rental fee for a timed rental portion), or the like.

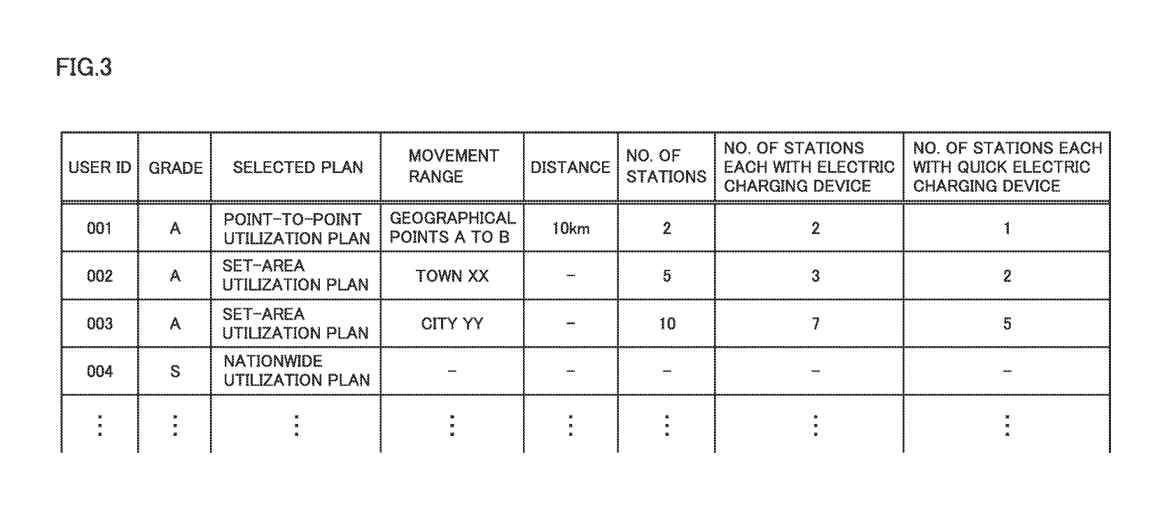

FIG. 3 shows an example of a configuration of the user list. As shown in FIG. 3, for example, the user list stores grades and utilization plans associated with user IDs “001” to “004” for the sake of illustration.

In the present embodiment, one of a plurality of grades is set for each of a plurality of users. The grade is set for the user in accordance with a predetermined criterion. The predetermined criterion for example includes at least any of: a criterion applied in determining whether the user utilizes an electric vehicle as frequently as or more frequently than a threshold value; a criterion applied in determining whether an amount of money paid to utilize an electric vehicle is equal to or more than a threshold value; and a criterion applied in determining whether a utilization plan has been selected which allows a user who pays a basic fee plus an additional fee to utilize a larger number of privileges and available services than a regular plan. A criterion applied in classifying grades is not particularly limited to the criteria described above.

In the present embodiment, it is assumed that a grade is set, for example, with reference to whether an additional fee is paid. Accordingly, a grade S is set for a user who pays the additional fee, and a grade A is set for a user who does not pay the additional fee. For example, the user of grade S can utilize a preferential service for reservation over the user of grade A. Details will be described later.

When management server 100 registers a user of rental of an electric vehicle to provide the user with membership therefor, management server 100 requests the user to provide the user's personal information and in addition select a grade that the user desires. For example, when management server 100 receives a desired grade from user terminal 500 or the like, management server 100 registers the received grade in the user list in association with the user ID of the user to be registered.

Further, as shown in FIG. 3, in association with a user ID with the point-to-point utilization plan selected, a movement range, a distance, a number of stations, a number of electric charging devices installed, and a number of quick electric charging devices installed are further registered as information accompanying the plan utilized. The point-to-point utilization plan is a plan permitting a rented electric vehicle to only move between two geographical points registered in advance.

When the point-to-point utilization plan is selected, two geographical points to be utilized are registered in advance in management server 100 as information accompanying the utilization plan, for example. For example, when a user selects the point-to-point utilization plan, management server 100 requests the user to set two geographical points. For example, when management server 100 receives information about two geographical points from user terminal 500, management server 100 associates the received two geographical points with a user ID and thus registers them in the user list.

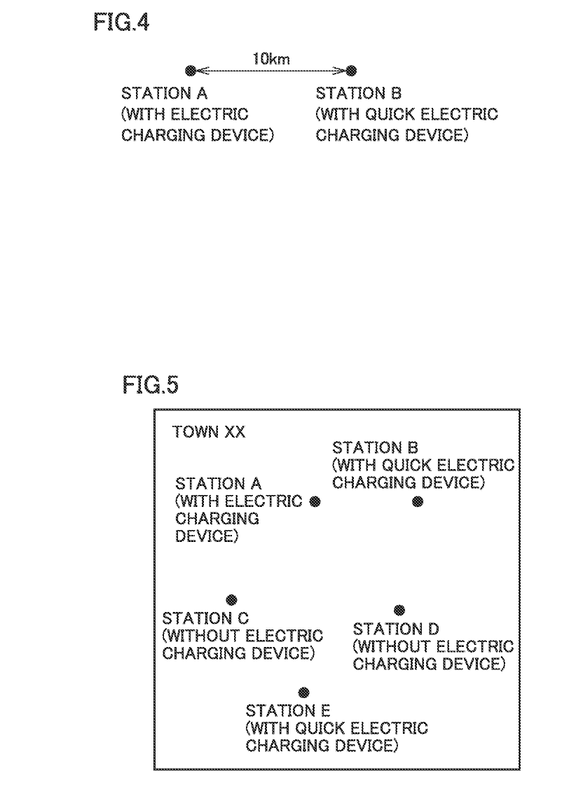

FIG. 4 is a diagram for illustrating the point-to-point utilization plan. As shown in FIG. 4, it is assumed that, for example, a geographical point A and a geographical point B which is about 10 km away from point A are registered. Then, it is assumed that a station A serving as a base for renting an electric vehicle at geographical point A has an electric charging device and no quick electric charging device and a station B at geographical point B has a quick electric charging device.

In that case, the movement range being from geographical point A to geographical point B, the distance being 10 km, and there being two stations, of which two stations each have an electric charging device (including a quick electric charging device) installed therein and one station has a quick electric charging device installed therein, are associated with user ID “001” as information accompanying the point-to-point utilization plan, and thus registered in the user list. Note that management server 100 obtains information such as the latitudes and longitudes of geographical points A and B from map information stored in storage 104 and sets as a distance of geographical points A and B a distance in a straight line calculated from the obtained latitude and longitude information or the like. Alternatively, management server 100 may set as a distance between geographical point A and geographical point B a shortest distance travelled by a vehicle along a road between geographical point A and geographical point B.

Further, as shown in FIG. 3, in association with a user ID with the set-area utilization plan selected, a movement range, a distance, a number of stations, a number of electric charging devices installed, and a number of quick electric charging devices installed are further registered as information accompanying the plan utilized. The set-area utilization plan is a plan permitting a rented electric vehicle to only move within a geographical region registered in advance for utilization. A geographical region in which a vehicle is utilized in the set-area utilization plan includes, for example, three or more stations.

When the set-area utilization plan is selected, a geographical region in which a vehicle is utilized is registered in advance in management server 100 as information accompanying the plan utilized, for example. For example, when a user selects the set-area utilization plan, management server 100 requests the user to set a geographical region in which a vehicle is utilized. For example, when management server 100 receives information from user terminal 500 about a geographical region in which a vehicle is utilized, management server 100 associates the received geographical region with a user ID and thus registers it in the user list.

FIG. 5 is a diagram for illustrating the set-area utilization plan. As shown in FIG. 5, it is assumed that a town XX is registered as a geographical region in which a vehicle is utilized. In town XX, stations A to E exist at five locations of geographical points A to E, and station A at geographical point A is provided with an electric charging device, stations B and E at geographical points B and E are provided with quick electric charging devices, respectively, and stations C and D at geographical points C and D are provided with no electric charging device for the sake of illustration.

In that case, for example, the movement range being town XX, and there being five stations, of which three stations each have an electric charging device installed therein and two stations each have a quick electric charging device installed therein, are associated with user ID “002” as information accompanying the set-area utilization plan, and thus registered in the user list.

Similarly, for example, the movement range being city YY, and there being ten stations, of which seven stations each have an electric charging device installed therein and five stations each have a quick electric charging device installed therein, are associated with user ID “003” as information accompanying a set-area utilization plan, and thus registered in the user list.

For a user ID with the nationwide utilization plan selected, only a grade and the plan utilized are associated. The nationwide utilization plan is a plan in which for example, the municipalities throughout a country are set as a movement range, that is, a rented electric vehicle has a substantially limitless movement range.

Management server 100 sets a rental fee for each user based on a grade, a utilization plan, and information accompanying the utilization plan that are set for a user ID. In the present embodiment, for example, a case of setting a rental fee for each prescribed period of time (of one month) (hereinafter referred to as a monthly fee) will be described as an example.

<Setting a Monthly Fee>

When a month ends and a subsequent month starts (or the first date of a month arrives) or when one month has elapsed since a time point at which utilization of an electric vehicle started, management server 100 sets a fee, based on matters registered in the user list, for a period of time from one month before to the day before.

For example, management server 100 refers to the user list and accordingly sets a basic fee for a monthly fee in accordance with a grade and a plan. The basic fee for the monthly fee set by the grade and the plan is a predetermined fee. Management server 100 sets a correction coefficient based on the information accompanying the plan. Management server 100 multiplies the basic fee by the set correction coefficient to set a monthly fee to be billed to the user. For example, for a user of grade S, management server 100 sets as a monthly fee a basic fee multiplied by a set correction coefficient plus a prescribed additional fee.

<Monthly Fee Setting Process>

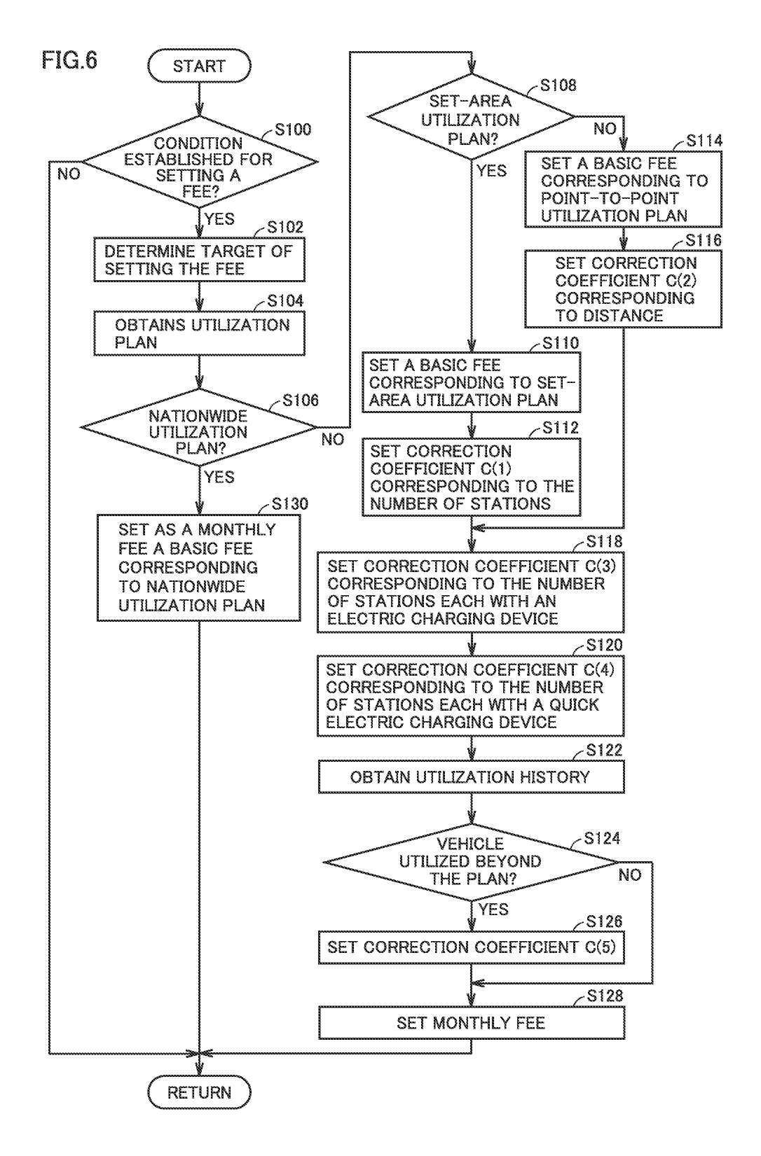

Hereinafter, a monthly fee setting process will be described in detail with reference to FIG. 6. FIG. 6 is a flowchart of the monthly fee setting process. In the present embodiment, the monthly fee setting process will be described as being executed by management server 100 (more specifically, CPU 102 of management server 100) for the sake of illustration. While each step shown in the flowchart shown in FIG. 6 is implemented by software processing done by management server 100, a part thereof may be implemented by hardware (or electric circuitry) fabricated in management server 100.

In step (“S”) 100, management server 100 determines whether a condition is established for executing setting a fee. For example, management server 100 determines that a condition is established for executing setting a fee when one month has elapsed since a time point at which the monthly fee setting process was performed immediately previously (or last month), or when the current date is the first date of a month, or the like. When it is determined that a condition is established for executing setting a fee (YES in S100), the process proceeds to S102.

In S102, management server 100 determines a user for whom a fee is set. Management server 100 determines as a user for whom a fee is set a user for whom the monthly fee setting process is still not done after a condition has been established for executing setting a fee. When it is determined that a condition has been established for executing the monthly fee setting process, management server 100 sets off a processing flag set for each of user IDs registered in the user list for example. Whenever a fee is set, management server 100 sets on a processing flag corresponding to a user ID for which the fee has been set. That is, management server 100 determines a user ID with a processing flag set off as a user for whom the monthly fee setting process is still not done.

In S104, management server 100 obtains a utilization plan selected by a user who is a target of the monthly fee setting process. Specifically, management server 100 refers to the user list to obtain the utilization plan.

In S106, management server 100 determines whether the obtained utilization plan is the nationwide utilization plan. When it is determined that the obtained utilization plan is the nationwide utilization plan (YES in S106), the process proceeds to S128.

On the other hand, when it is determined that the obtained utilization plan is not the nationwide utilization plan (NO in S106), the process proceeds to S108.

In S108, management server 100 determines whether the obtained utilization plan is the set-area utilization plan. When it is determined that the obtained utilization plan is the set-area utilization plan (YES in S108), the process proceeds to S110.

In S110, management server 100 sets a basic fee corresponding to the set-area utilization plan. The basic fee corresponding to the set-area utilization plan is a predetermined fee.

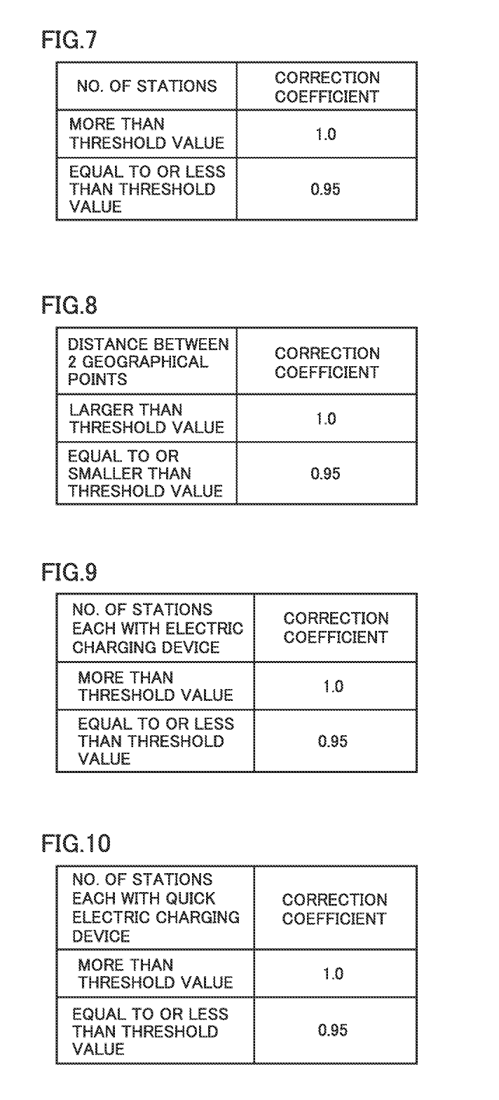

In S112, management server 100 refers to the information accompanying the utilization plan to set a correction coefficient C(1) corresponding to the number of stations. FIG. 7 is a diagram for explaining a correction coefficient set depending on the number of stations. For example, as shown in FIG. 7, when the number of stations is equal to or less than a threshold value, management server 100 may set a prescribed value smaller than 1.0 (e.g., 0.95) as the correction coefficient C(1), whereas when the number of stations is larger than the threshold value, management server 100 may set 1.0 as the correction coefficient C(1). The correction coefficient C(1) thus allows a monthly fee of a smaller amount to be set for a smaller number of stations than a larger number of stations.

On the other hand, when it is determined that the obtained utilization plan is not the set-area utilization plan (NO in S108), the process proceeds to S114.

In S114, management server 100 sets a basic fee corresponding to a point-to-point utilization plan. Note that for a given grade, the basic fee of the point-to-point utilization plan is a predetermined fee having a smaller amount than the basic fee of the set-area utilization plan.

In S116, management server 100 refers to the information accompanying the utilization plan to set a correction coefficient C(2) corresponding to a distance between the two geographical points. FIG. 8 is a diagram for explaining the correction coefficient set depending on a distance between two geographical points. For example, as shown in FIG. 8, when the distance is equal to or less than a threshold value, management server 100 may set a prescribed value smaller than 1.0 (e.g., 0.95) as the correction coefficient C(2), whereas when the distance is larger than the threshold value, management server 100 may set 1.0 as the correction coefficient C(2). The correction coefficient C(2) thus allows a monthly fee of a smaller amount to be set for two geographical points registered as a movement range that have a smaller distance therebetween than two geographical points registered as a movement range that have a larger distance therebetween.

In S118, management server 100 sets a correction coefficient C(3) corresponding to the number of stations within the movement range each having an electric charging device installed therein. FIG. 9 is a diagram for explaining a correction coefficient set depending on the number of stations each with an electric charging device installed therein. For example, as shown in FIG. 9, when the number of stations within the movement range each having an electric charging device installed therein is equal to or less than a threshold value, management server 100 may set a prescribed value smaller than 1.0 (e.g., 0.95) as the correction coefficient C(3), whereas when the number of stations within the movement range each having an electric charging device installed therein is larger than the threshold value, management server 100 may set 1.0 as the correction coefficient C(3). The correction coefficient C(3) thus allows a monthly fee of a smaller amount to be set for a movement range including a smaller number of stations each having an electric charging device installed therein than a movement range including a larger number of stations each having an electric charging device installed therein.

In S120, management server 100 sets a correction coefficient C(4) corresponding to the number of stations within the movement range each having a quick electric charging device installed therein. FIG. 10 is a diagram for explaining a correction coefficient set depending on the number of stations each with a quick electric charging device installed therein. For example, as shown in FIG. 10, when the number of stations within the movement range each having a quick electric charging device installed therein is equal to or less than a threshold value, management server 100 may set a prescribed value smaller than 1.0 (e.g., 0.95) as the correction coefficient C(4), whereas when the number of stations within the movement range each with a quick electric charging device installed therein is larger than the threshold value, management server 100 may set 1.0 as the correction coefficient C(4). The correction coefficient C(4) thus allows a monthly fee of a smaller amount to be set for a movement range including a smaller number of stations each with a quick electric charging device installed therein than a movement range including a larger number of stations each with a quick electric charging device installed therein.

In S122, management server 100 obtains a utilization history of the vehicle rented to the user. For example, while vehicle 200 is being used by the user, vehicle 200 stores a history of positional information of vehicle 200 to storage 206. When vehicle 200 is returned to a station, vehicle 200, in response to a request received from management server 100, associates the history of the positional information of vehicle 200 stored in storage 206 with a user ID and thus transmits it via communication device 202 to management server 100. Management server 100 stores the received history of the positional information to storage 104 as utilization history information associating the user ID and a period of time for which the vehicle is utilized with each other. Management server 100 refers to the utilization history information to obtain a utilization history.

In S124, management server 100 determines whether the vehicle has been utilized beyond the plan. For example, when the vehicle is used beyond the movement range set from the utilization history of the immediately preceding month to correspond to the plan, management server 100 determines that the vehicle has been utilized beyond the plan. When it is determined that the vehicle has been utilized beyond the plan (YES in S124), the process proceeds to S126.

In S126, management server 100 sets a correction coefficient C(5). For example, management server 100 sets 1.2 as the correction coefficient C(5). The correction coefficient C(5) allows a monthly fee of a larger amount to be set when the vehicle is utilized beyond the plan than when it is not. Note that the correction coefficient C(5) has an initial value set to 1.0 and the correction coefficient C(5) has a value reset to the initial value when a condition for setting a fee is established for the sake of illustration. On the other hand, when it is determined that the vehicle has not been utilized beyond the plan (NO in S124), the process proceeds to S128.

In S128, management server 100 sets a monthly fee. Specifically, for example, management server 100 sets a monthly fee by multiplying a basic fee by a correction coefficient of correction coefficients C(1) to C(5) that is set to correspond to a utilization plan or utilization beyond a plan.

In S130, management server 100 sets as a monthly fee a basic fee corresponding to the nationwide utilization plan. Note that for a given plan, the basic fee corresponding to the nationwide utilization plan is a predetermined fee having a larger amount than any of the basic fee of the set-area utilization plan and the basic fee of the point-to-point utilization plan.

<Operation of Management Server 100 Serving as Rental Fee Setting Apparatus>

An operation of management server 100 which is a rental fee setting apparatus based on the above configuration and flowchart will now be described.

When it is determined that since a fee was immediately previously set a period of one month has elapsed and a condition for performing a fee setting process is established (YES in S100), a user for whom a fee is set is determined (S102) and a utilization plan to be applied to the user for whom the fee is set is obtained (S104).

When it is determined that the obtained utilization plan is the nationwide utilization plan (YES in S106), a basic fee corresponding to the nationwide utilization plan is set as a monthly fee (S130).

On the other hand, when it is determined that the obtained utilization plan is not the nationwide utilization plan (NO in S106) and the plan is instead a set-area utilization plan (YES in S108), a basic fee corresponding to the set-area utilization plan is set (S110). Accordingly, a correction coefficient C(1) corresponding to the number of stations within the movement range is set (S112), a correction coefficient C(3) corresponding to the number of stations each with an electric charging device installed therein is set (S118), and a correction coefficient C(4) corresponding to the number of stations each with a quick electric charging device installed therein is set (S120).

Then, a utilization history for one month is obtained (S122), and when there is no utilization beyond the plan in the obtained utilization history (NO in S124), each of the correction coefficients (1), (3) and (4) are applied to multiply the basic fee of the set-area utilization plan to thus set a monthly fee (S128).

Furthermore, when it is determined that the obtained utilization plan is not a set-area utilization plan (NO in S108), a point-to-point utilization plan will be applied. Accordingly, a basic fee corresponding to the point-to-point utilization plan is set (S114), and a correction coefficient C(2) corresponding to the distance between the points is set (S116). Then, a correction coefficient C(3) corresponding to the number of stations within the movement range each with an electric charging device installed therein is set (S118), and a correction coefficient C(4) corresponding to the number of stations within the movement range each with a quick electric charging device installed therein is set (S120).

Then, a utilization history for one month is obtained (S122), and when there is utilization beyond the plan in the obtained utilization history (YES in S124), the correction coefficient (5) is set (S126). Accordingly, a monthly fee is set by multiplying the basic fee of the point-to-point utilization plan by each of the correction coefficients (2) to (5) (S128).

<Reservation Receiving Process by Management Server 100>

As has been set forth above, a grade S user can utilize preferential service regarding reservation over a grade A user.

When management server 100 receives a reservation via user terminal 500, management server 100 does so in a manner varying depending on a grade associated with a user ID transmitted from user terminal 500.

Specifically, management server 100 receives a reservation for rental of an electric vehicle for a scheduled utilization period of time, and management server 100 does so at or after a reservation receivable time point earlier by a predetermined period of time than the starting time of the scheduled utilization period of time. In that case, management server 100 corresponds to a “reservation receiving device.” The predetermined period of time is set for each grade. In the present embodiment, a predetermined period of time set for grade S is a period of time longer than a predetermined period of time set for grade A. A predetermined period of time set for grade S is for example one day, and a predetermined period of time set for grade A is for example 30 minutes.

In this way, a user set to grade S can make a reservation for rental of an electric vehicle one day before the starting time of a scheduled utilization period of time, whereas a user set to grade A can only make a reservation for rental of an electric vehicle 30 minutes before the starting time of a scheduled utilization period of time. The user set to grade S will thus receive a preferential service over the user set to grade A for making a reservation for rental of an electric vehicles.

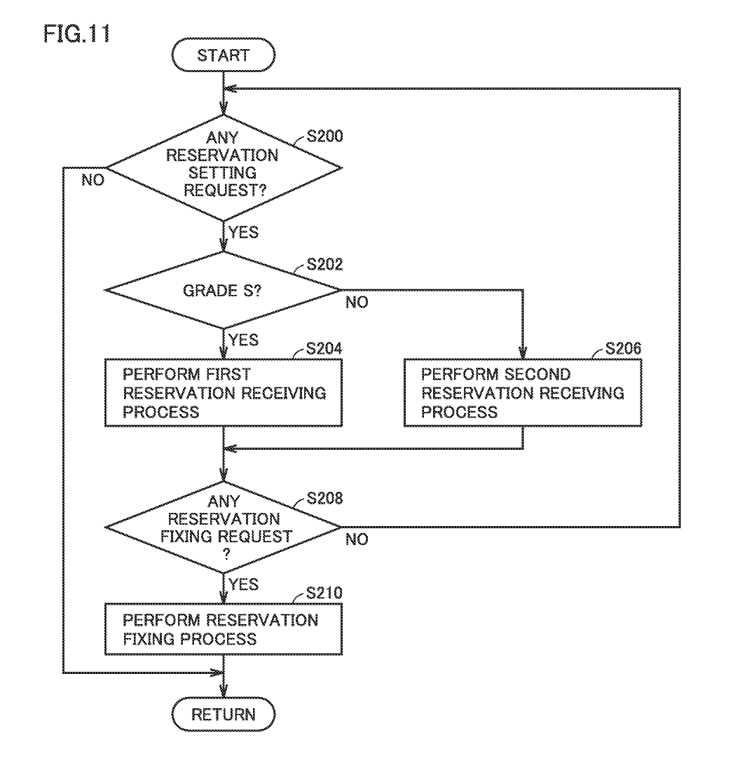

Hereinafter, the reservation receiving process will be described in detail with reference to FIG. 11. FIG. 11 is a flowchart of the reservation receiving process. In the present embodiment, the reservation receiving process will be described as being performed by management server 100 (more specifically, CPU 102 of management server 100) for the sake of illustration. While each step shown in the flowchart shown in FIG. 11 is implemented by software processing done by management server 100, a part thereof may be implemented by hardware (or electric circuitry) fabricated in management server 100.

In step 200, management server 100 determines whether there is a reservation setting request. For example, management server 100 determines that there is a reservation setting request when management server 100 receives from user terminal 500 a signal indicating a reservation setting request. When it is determined that there is a reservation setting request (YES in S200), the process proceeds to S202.

In S202, management server 100 determines whether the reservation setting request is made by a user of grade S. For example, management server 100 obtains a user ID together with the reservation setting request, and uses the obtained user ID to refer to the user list to determine whether the user is a user of grade S. When it is determined that the reservation setting request is made by a user of grade S (YES in S202), the process proceeds to S204. On the other hand, when it is determined that the user is not a user of grade S (NO in S202), the process proceeds to S206.

In S204, management server 100 performs a first reservation receiving process. The first reservation receiving process is a process performed to receive a reservation for rental of an electric vehicle for a scheduled utilization period of time such that the reservation is received at or after a reservation receivable time point earlier by a predetermined first period of time than the starting time of the scheduled utilization period of time. In other words, the first reservation receiving process is a process for receiving a reservation for rental of an electric vehicle such that the reservation is received during a period or time from the current time point to a time point later than the current time point only by the predetermined first period of time. The first period of time is for example one day. That is, in the first reservation receiving process, a reservation can be made such that a time point during a period of time from the current time point to a time point one day thereafter serves as a time point at which utilizing an electric vehicle starts.

In S206, management server 100 performs a second reservation receiving process. The second reservation receiving process is a process performed to receive a reservation for rental of an electric vehicle for a scheduled utilization period of time such that the reservation is received at or after a reservation receivable time point earlier by a predetermined second period of time than the starting time of the scheduled utilization period of time. In other words, the second reservation receiving process is a process for receiving a reservation for rental of an electric vehicle such that the reservation is received during a period or time from the current time point to a time point later than the current time point only by the predetermined second period of time. The second period of time is for example 30 minutes. That is, in the second reservation receiving process, a reservation can be made with a period of time from the current time point to the time point later than the current time point by 30 minutes as a time point at which utilizing an electric vehicle starts.

In S208, management server 100 determines whether a reservation has been fixed. For example, management server 100 determines that the reservation has been fixed when management server 100 receives a signal indicating a reservation fixing request from user terminal 500. When it is determined that the reservation is fixed (YES in S208), the process proceeds to S210.

In S210, management server 100 performs a reservation fixing process for storing the fixed reservation's details (a renting date and time, a scheduled returning date and time, a vehicle type, etc.) to storage 104.

As described above, in the reservation receiving process, for example, when there is a reservation setting request from a user via user terminal 500 (YES in S200), and the user is a user of grade S (YES in S202), the first reservation receiving process is performed (S204). On the other hand, when the user's grade is grade A (NO in S202), the second reservation receiving process is performed (S206). If there is a reservation fixing request (YES in S208), the reservation fixing process is performed (S210), and the reservation's details are stored to storage 104 of management server 100. This allows a user set to grade S to reserve a scheduled later utilization period of time than a user set to grade A and thus be given precedence over the user of grade A in making a reservation.

<Function and Effect of Rental Fee Setting Apparatus>

Thus the rental fee setting apparatus according to the present embodiment allows a lower rental fee to be set for a movement range having a smaller number of stations therein. Thus, a rental fee lower than for a more convenient geographical region is set. A fee can be set to sufficiently satisfy a user in a geographical region including a small number of stations. Thus there can be provided a rental fee setting apparatus, method and system that sets a rental fee of an electric vehicle to be rented to a user while considering a condition of a geographical region where the vehicle is utilized so that the user is sufficiently satisfied with the set rental fee.

Furthermore, a different rental fee is set for a registered movement range including a different number of stations each with an electric charging device installed therein. A user's convenience in utilizing an electric vehicle within a registered movement range varies when the registered movement range has a different number of stations each with an electric charging device installed therein. Accordingly, by setting a different rental fee while considering a geographical region in which the vehicle is utilized, the rental fee can sufficiently satisfy a user.

Furthermore, a different rental fee is set for a registered movement range including a different number of stations each with a quick electric charging device installed therein. A user's convenience in utilizing an electric vehicle within a registered movement range varies when the registered movement range has a different number of stations each with a quick charging device installed therein. Accordingly, by setting a different rental fee while considering a geographical region in which the vehicle is utilized, the rental fee can sufficiently satisfy a user.

<Modifications>

While the above-described embodiment has been described with a correction coefficient set to be applied to a basic fee, setting a correction coefficient is not a limitation insofar as a fee is substantially discounted. For example, instead of a correction coefficient, a returning rate associated with a monthly fee may be set and applied to provide a rebate by cash, a voucher or a variety of types of points, or a discount rate associated with a monthly fee may be set and applied to discount the monthly fee. For the returning rate and the discount rate, for example, returning and discount rates corresponding to the correction coefficients C(1) to C(4) may be set and added together to set final returning and discount rates.

Furthermore, while the above-described embodiment has been described such that a correction coefficient of the correction coefficients C(1) to C(5) for correcting a basic fee, that corresponds to a plan is set, for example, setting a different basic fee depending on the plan suffices, and setting at least one of the correction coefficients C(1) to C(5) suffices.

Furthermore, while in the above-described embodiment a case of setting a monthly fee for a manner of utilization in a leasing system leasing an electric vehicle until a prescribed term of a contract (of one year or several years) expires as a manner of utilization of rental has been described as an example, for example, a rental fee may be set to correspond to a permitted movement range, as has been described above, for a manner of utilization in a rental system setting a fee per prescribed period of time and collecting a fee for a utilization period of time. Alternatively, a rental fee may be set to correspond to a permitted movement range, as has been described above, for a manner of utilization in an electric vehicle sharing system in which a plurality of people share one or more electric vehicles, and a fee is set every prescribed period of time (e.g., one month later) until a prescribed term of a contract expires or a fee corresponding to a utilization period of time is collected.

Furthermore, in the above-described embodiment, the correction coefficients C(1) to C(4) are described as having an upper limit value of 1.0, a value greater than 1.0 may alternatively be set.

Furthermore, while the above-described embodiment has been described such that a fee is set to be a smaller amount for a shorter distance, a smaller number of stations each with an electric charging device installed therein, or a smaller number of stations each with a quick electric charging device installed therein, for example a fee may be set to be a smaller amount for a longer distance, a larger number of stations each with an electric charging device installed therein, or a larger number of stations each with a quick electric charging device installed therein.

Furthermore, while in the above-described embodiment an example has been described in which a correction coefficient is changed by a threshold value in two stages, a plurality of threshold values may be used to change a correction coefficient in three or more stages.

Furthermore, while in the above-described embodiment an example has been described in which a grade set for a user is set in advance, it may be set ex post facto based on a cumulative value of how many times the user utilizes an electric vehicle, a cumulative utilization fee, or the like.

It should be noted that the above modifications may be implemented all together or may partially be implemented in combination.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A rental fee setting apparatus configured to set a rental fee for an electric vehicle comprising a power storage device mounted therein, the rental fee setting apparatus comprising:
a storage device configured to store a movement range selected by a user from a plurality of movement ranges, the plurality of movement ranges including (i) a first movement range allowing the electric vehicle to move therein when the electric vehicle is rented and (ii) a second movement range being different from the first movement range and including a smaller number of stations each serving as a base for renting the electric vehicle than the first movement range; and
a setting device configured to set a rental fee for the electric vehicle based on the selected movement range,
the setting device being configured to set a lower rental fee when the second movement range is selected than when the first movement range is selected.

2. The rental fee setting apparatus according to claim 1, wherein when a number of stations with an electric charging device in the first movement range is different from a number of stations with an electric charging device in the second movement range, the setting device is configured to set different rental fees for the movement ranges.

3. The rental fee setting apparatus according to claim 1, wherein when a number of stations with a quick electric charging device in the first movement range is different from a number of stations with a quick charging device in the second movement range, the setting device is configured to set different rental fees for the movement ranges.

4. The rental fee setting apparatus according to claim 1, further comprising a reservation receiving device configured to receive a reservation for rental of the electric vehicle for a scheduled utilization period of time, the reservation receiving device receiving the reservation no earlier than a reservation receivable time point earlier by a predetermined period of time than a starting time of the scheduled utilization period of time, wherein
the storage device is configured to store in association with the user a grade of a plurality of grades set in accordance with a predetermined criterion, and
the predetermined period of time is set for each grade.

5. A method for setting a rental fee for an electric vehicle comprising a power storage device mounted therein, the method comprising:
storing a movement range selected by a user from a plurality of movement ranges, the plurality of movement ranges including (i) a first movement range allowing the electric vehicle to move therein when the electric vehicle is rented and (ii) a second movement range being different from the first movement range and including a smaller number of stations each serving as a base for renting the electric vehicle than the first movement range;
setting a rental fee for the electric vehicle based on the selected movement range; and
setting a lower rental fee when the second movement range is selected than when the first movement range is selected.

6. A rental fee setting system comprising:
an electric vehicle including a power storage device mounted therein; and
a server configured to set a rental fee for the electric vehicle,
the server being configured to:
store a movement range selected by a user from a plurality of movement ranges, the plurality of movement ranges including (i) a first movement range allowing the electric vehicle to move therein when the electric vehicle is rented and (ii) a second movement range being different from the first movement range and including a smaller number of stations each serving as a base for renting the electric vehicle than the first movement range;
set a rental fee for the electric vehicle based on the selected movement range; and
set a lower rental fee when the second movement range is selected than when the first movement range is selected.
